(19) United States
(12) Patent Application Publication
(10) Pub. No.: US 2013/0232256 A1
(43) Pub. Date: Sep. 5, 2013

(54) SYSTEM AND METHOD FOR PROVIDING RANKING INFORMATION OF MOBILE APPLICATION

(71) Applicants: Haejin LEE, Seongnam-si (KR); JungHo SHIN, Seongnam-si (KR); Jungmin LEE, Seongnam-si (KR)

(72) Inventors: Haejin LEE, Seongnam-si (KR); JungHo SHIN, Seongnam-si (KR); Jungmin LEE, Seongnam-si (KR)

(73) Assignee: NHN CORPORATION, Seongnam-si (KR)

(21) Appl. No.: 13/599,400

(22) Filed: Aug. 30, 2012

(30) Foreign Application Priority Data
Aug. 31, 2011 (KR) 10-2011-0087744

(51) Int. Cl. H04L 12/26

(52) U.S. Cl. CPC H04L 43/04
USPC 709/224

(57) ABSTRACT

Provided is a system and method for providing ranking information of a mobile application using information obtained from a user terminal. A server for providing ranking information of an application on the Internet may include a collecting unit to collect, with regard to at least one first application installed in a communication terminal, at least one of use information indicating a position of an icon of the first application on a wallpaper, that is, an application managing interface of the communication terminal, and use information indicating the first application currently being executed in the memory of the communication terminal; and a providing unit to provide a ranking of the first application based on statistics of use information.

### CROSS-REFERENCE TO RELATED APPLICATION

This application claims priority from and the benefit of Korean Patent Application No. 10-2011-0087744, filed on Aug. 31, 2011, which is hereby incorporated by reference for all purposes as if fully set forth herein.

### BACKGROUND OF THE INVENTION

1. Field of the Invention

Exemplary embodiments of the present invention relate to a system and method for providing ranking information of a mobile application using information obtained from a user terminal.

2. Discussion of the Background

An App Store, which refers to an Application Store, is a market place for online is mobile content, that is, software for mobile applications, for example, content application programs to be installed on a mobile phone such as schedule manager, address book, alarm, calculator, game, video, Internet connection, music player, navigation, Word, Excel, etc., are available to be freely purchased and sold.

The App Store is an open market place where applications may be developed and sold by individuals rather than being developed by a large enterprise and subsequently sold by telecommunication providers. Using programs such as a software development kit (SDK), Xcode, etc., released by a management company, anyone developing their own applications may be able to sell applications to smart phone users globally. When an application created by an individual developer is registered in the App Store, consumers may connect to a wireless communication network to select and download an application to a mobile phone, or to transfer the selected application to the mobile phone after downloading the application to a personal computer (PC).

Since numerous applications are offered in the App Store, a user may have to spend a considerable amount of time to locate an application. Korean Patent Publication No. 10-2011-0020178 (published on Mar. 2, 2011) discloses a technology to search for an application compatible with a user terminal by providing a list of applications created based on user terminal information. Furthermore, conventionally, for the convenience of a user performing a search, applications provided by the App Store are classified into various categories. Alternatively, guide applications exist in multiple App Stores, to introduce applications available for purchase. However, since a conventional art merely provides a list of applications intuitively classified, the conventional art is faced with limits in providing a service of introducing an application and providing a user-friendly search.

Exemplary embodiments of the present invention are directed to suggesting a service model for providing a variety of rankings of a mobile application using application use information obtained from one or more user terminals.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

Exemplary embodiments of the present invention provide a system and method for providing a combined ranking of an application on the Internet by obtaining use information of an application installed in a user terminal and using the obtained use information.

Exemplary embodiments of the present invention also provide a system and method for providing an application ranking based on a position of an icon of an application arranged on an application managing interface of a user terminal by a user.

Exemplary embodiments of the present invention also provide a system and method for providing a variety of ranking information based on a preceding day and a real-time ranking of an application currently being executed most frequently by terminal users.

Additional features of the invention will be set forth in the description which follows, and in part will be apparent from the description, or may be learned by practice of the invention.

An exemplary embodiment of the present invention discloses a communication is terminal including one or more processors, a memory, and a plurality of programs, wherein the plurality of programs are configured to be stored in the memory and executed by the one or more processors, and the plurality of programs include at least one first application and a second application to collect use information associated with the first application. The second application may include an information collecting code to collect at least one of use information indicating a position of an icon of the first application on a wallpaper, that is, an application managing interface, and use information indicating the first application currently being executed, and an information transmission code to transmit the use information to a host system associated with the second application, wherein the use information is used as a ranking determining factor to determine a ranking of the first application.

Another exemplary embodiment of the present invention discloses a server for providing ranking information of an application on the Internet, including a collecting unit to collect, with regard to at least one first application installed in a communication terminal, at least one of use information indicating a position of an icon of the first application on a wallpaper, that is, an application managing interface of the communication terminal, and use information indicating the first application currently being executed in a memory of the communication terminal, and a providing unit to provide a ranking of the first application based on statistics of the use information.

Still another exemplary embodiment of the present invention discloses a method of controlling a communication terminal, wherein at least one first application and a second application to collect use information associated with the first application are installed in the communication terminal, and the method may include collecting at least one of use information indicating a position of an icon of the first application on a wallpaper, that is, an application is managing interface, and use information indicating the first application currently being executed, and transmitting the use information to a host system associated with the second application, wherein the use information is used as a ranking determining factor to determine a ranking of the first application in the host system.

Still another exemplary embodiment of the present invention discloses a method for controlling a server to provide ranking information of an application on the Internet, with regard to at least one first application installed in a communication terminal, may include collecting at least one of the use information indicating the position of the icon of the first application on the wallpaper, that is, an application managing interface, and use information indicating the first application currently being executed, and providing a ranking of the first application based on statistics of the use information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIGS. 1 and 2 illustrate a service model for providing ranking information of an application on the Internet according to an exemplary embodiment of the present invention.

FIG. 3 is a flowchart illustrating a process of a program collecting and is transmitting use information of an application in a user terminal to a server according to an exemplary embodiment of the present invention.

FIG. 4 illustrates an example of a ranking logic used to collect use information based on a position of an icon of an application in a user terminal according to an exemplary embodiment of the present invention.

FIG. 5 is a block diagram illustrating an internal configuration of a server for providing ranking information of an application based on statistics of actual use by users of an application in a user terminal according to an exemplary embodiment of the present invention.

FIG. 6 is a flowchart illustrating a method of providing ranking information of an application based on statistics of actual use by users of an application in a user terminal according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element or layer is referred to as being “directly connected to” is another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Exemplary embodiments of a server system and a user terminal for providing ranking information of an application on the Internet are described hereinafter.

As used herein, the term ‘application’ may also be referred to as ‘App’ and may indicate any application that is installable in a communication terminal. Further, a user terminal may indicate any communication terminal such as a personal computer (PC), a tablet PC, a smart phone, and the like that may have an App and establish a network connection to a server system. Here, the user terminal may include a touch sensing display as an example of a display device. A contact point between the touch sensing display and a user may correspond to one or more fingers of the user or a stylus pen.

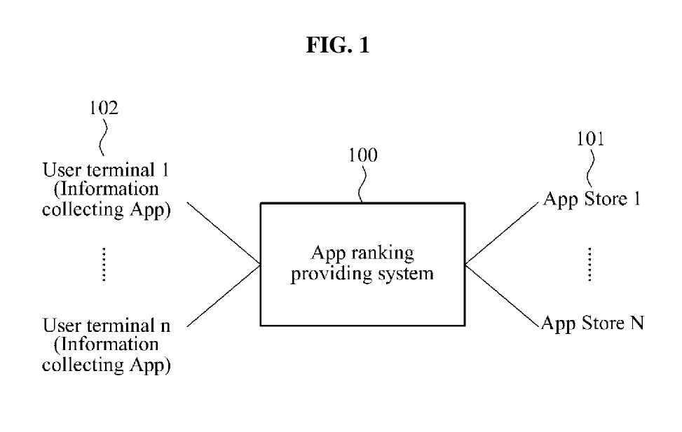

FIG. 1 illustrates a service model for providing ranking information of an App on the Internet using use information of a user. Here, the App on the Internet may refer to any App registered in a plurality of App Stores 101 providing a service of downloading an App to a plurality of user terminals 102. Users may download and install a desired App from the plurality of App Stores 101 in the plurality of user terminals 102 after connecting to the plurality of App Stores 101. Accordingly, an App ranking providing system 100 may provide ranking information of an App in the plurality of App Stores 101 by analyzing App data of users actually downloading the App.

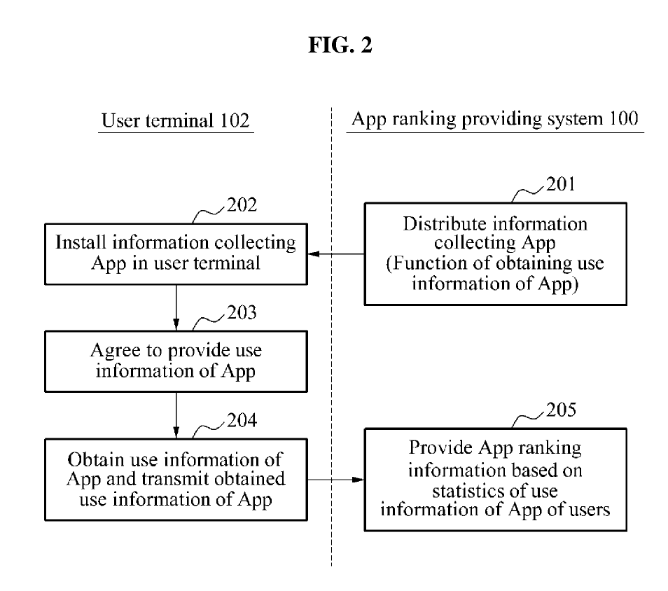

In the present exemplary embodiment, the App ranking providing system 100 may provide a variety of App rankings, with regard to a user's actual using an App, according to a ranking logic that is internally embodied, based on various features, hereinafter referred to as is ‘use information’, obtainable from the user terminal 102. Referring to FIG. 2, in operation 201, the App ranking providing system 100 may also provide an application, hereinafter referred to as an ‘information collecting App’, that includes a function of collecting, from the plurality of user terminals 102, use information of an App installed in the plurality of user terminals 102. Here, the information collecting App may be configured in combination with a ranking providing App to provide ranking information of an App on the Internet, or configured to be a separate App from the ranking providing App. During operation 202 of downloading and installing the information collecting App in the user terminal 102 by a user, when the user agrees to provide the use information of the App to the App ranking providing system 100, that is, a host system, in operation 203, the information collecting App may automatically collect the use information of the App and transmit the collected use information to the App ranking providing system 100 in operation 204. Accordingly, in operation 205, the App ranking providing system 100 may determine an App ranking based on statistics of an App used by actual users by collecting the use information of the App from the user terminal 102 in which the information collecting App is installed. Here, App ranking information determined based on the use information of the App obtained from the user terminal 102 may be provided by the information collecting App or a separate application, or on various platforms.

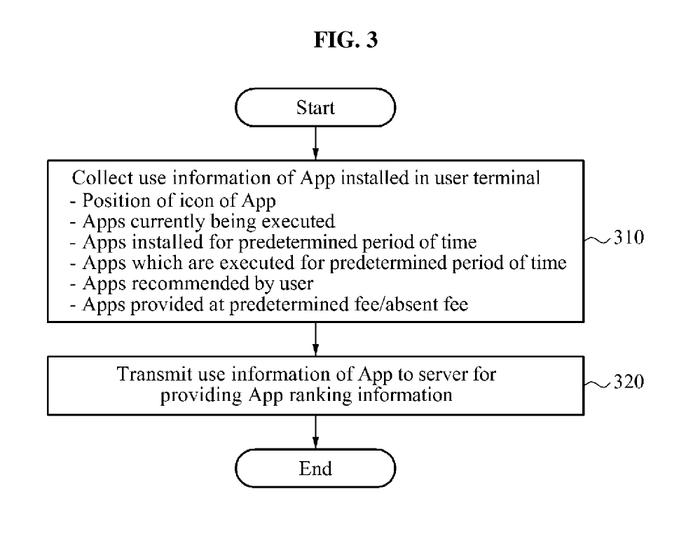

A process of the information collecting App will be further described hereinafter with reference to FIG. 3.

FIG. 3 is a flowchart illustrating a process of an information collecting App collecting and transmitting the use information of an application installed in a user terminal to a server, according to an exemplary embodiment of the present invention. The information collecting App may include an information collecting code to collect the use information of the App, and an information transmitting code to transmit the use information of the App to the server.

In operation 310, the user terminal may function to collect use information of an App in the user terminal using the information collecting code of the information collecting App.

In the present exemplary embodiment, use information of an App installed in a user terminal is as follows.
(1) Use information indicating a position of an icon of an App on a wallpaper of a user terminal
(2) Use information indicating an App currently being executed in a memory of a user terminal
(3) Use information indicating an App installed by being downloaded or updated in a user terminal for a predetermined recent period of time
(4) Use information indicating an App being executed recently in a user terminal for a certain period of time
(5) Use information indicating whether an App installed in a user terminal is provided at a predetermined fee or absent a fee
(6) Use information indicating whether an App is recommended by a user of a user terminal

The use information (1) of the aforementioned use information of the App may be used as a ranking determining factor to aggregate a ranking by evaluating accessibility as to whether a user arranges an icon at an easily accessible position and thereby uses the icon. In addition, the use information (2) may also be used as a ranking determining factor to aggregate a real-time popular ranking by analyzing an App currently being executed most frequently by is terminal users. Furthermore, the use information (3) may also be used as a ranking determining factor to aggregate a ranking by determining a number of instances in which users install an App in the user terminal for a predetermined recent period of time, for example, one day. Further, the use information (4) may also be used as a ranking determining factor to aggregate a ranking by determining a number of instances in which users execute an App in the user terminal for a predetermined recent period of time. Also, the use information (5) may also be used as a ranking determining factor to aggregate a ranking by distinguishing between an App provided at a predetermined fee and an App provided absent a fee and thereby determining a number of instances in which the App provided at a predetermined fee is installed and a number of instances in which the App provided absent a fee is installed, respectively. Also, the use information (6) may also be used as a ranking determining factor to aggregate a ranking by determining a number of instances in which an App is recommended by users for a predetermined recent period of time.

More particularly, the use information (1) of the aforementioned use information of the App may include a weight applied to the position at which the icon is arranged on the wallpaper. With regard to the wallpaper, that is, an application managing interface, the user terminal may have a position value such as a coordinate value. In consideration of the accessibility of the user, the user terminal may apply a weight to the wallpaper according to the position value. In addition, as an example of an access environment of the wallpaper, right-handed and left-handed settings may be included as needed. In a case of a right-handed person, a lower right portion of the wallpaper may correspond to the front and thus, be defined to have a higher accessibility. Conversely, in a case of a left-handed person, a lower left portion of the wallpaper may correspond to the front and thus, be defined to have a higher accessibility.

As an example, a weight applied to an icon arranged in an earlier front page may be relatively higher than a weight applied to an icon arranged in a later back page. As another example, when the wallpaper includes at least one page, based on an access environment set on the wallpaper, a weight applied to an icon arranged earlier on a page may be relatively higher than an icon arranged later on a page between icons on a same page. As yet another example, when the wallpaper includes at least one page in which the wallpaper is divided into a plurality of regions, based on an access environment set on the wallpaper, a weight applied to an icon arranged in a region with a high user accessibility may be relatively higher than a weight applied to an icon arranged in a region with a low user accessibility.

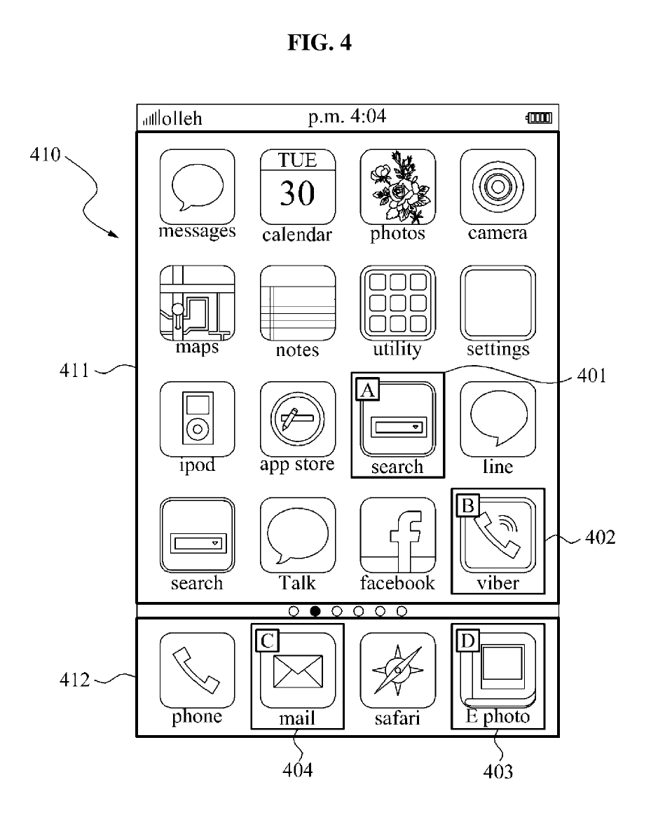

Referring to FIG. 4, when an access environment is set up for a right-handed user, and in a case of being on a same page as the wallpaper, a weight applied to an icon B 402 may be relatively higher than a weight applied to an icon A 401. Also, in a case of dividing the wallpaper 410 into a first region 411 and a second region 412, a user tends to arrange a frequently used icon of an App in the second region 412. Accordingly, a weight applied to an icon C 404 arranged in the second region 412 may be relatively higher than the icon B 402 arranged in the first region 411. Similarly, on an android-based application managing interface, a wallpaper may include a ‘Home’ page and a ‘main menu’ page. In a case of an App frequently used by a user, an icon of the App is arranged on the Home page, and therefore, a weight applied to an icon arranged in the Home page may also be relatively higher than a weight applied to an icon arranged in the main menu page. Further, although the icon C 404 and an icon D 403 are arranged within the same second region 412, a weight applied to the icon C 404 which is arranged earlier in the second region 412 may be relatively higher than a weight applied to the icon D 403. Therefore, the use information (1) may be used to analyze the accessibility of users is on the App and to aggregate a ranking of the App arranged in a position easily accessible.

Further, the use information (2) is use information indicating an App currently stored in a memory in a user terminal. In this instance, the App currently stored in the memory may indicate an App currently being used, and the use information (2) may include a weight applied to an App currently being executed in the memory. That is, the use information (2) may be used to aggregate a real-time popular ranking by analyzing the App currently being executed by terminal users.

Referring once more to FIG. 3, in operation 320, the user terminal may transmit the use information of the App collected in operation 310 to the server using the information transmission code of the information collecting App. When an App is being executed, the use information (2) of the aforementioned use information of the App may be transmitted in real time to the server. The remaining use information of the aforementioned use information of the App may be transmitted at predetermined intervals, or may be transmitted when there is a change in use information of a previous interval. Here, an App ranking providing system, that is, a server system, may aggregate an App ranking based on the use information of the App including at least one of the aforementioned use information (1), (2), (3), (4), (5) and (6) that is collected from the user terminal.

Although a configuration of a user terminal to provide use information of an App that a user actually uses via an information collecting App is not shown, the user terminal may include a memory, more than one processor, and a plurality of programs. Here, the plurality of programs may be configured to be stored in the memory and implemented by the more than one processor, and may include at least one App and an information collecting App to collect the use information of the App. In addition, the user terminal may include a communication module to is permit communication with an App ranking providing system, that is, a server system, by supporting various communication protocols such as code division multiple access (CDMA), wideband code division access (WCDMA), long term evolution (LTE), wireless fidelity (Wi-Fi), Bluetooth, and the like.

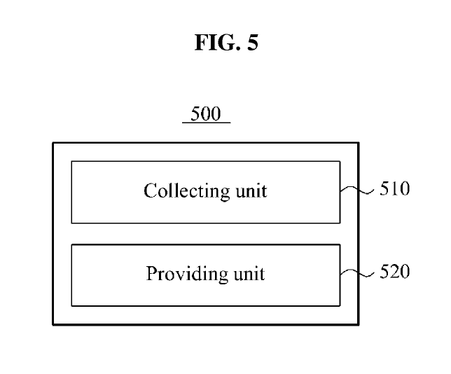

An internal configuration of the App ranking providing system to aggregate an App ranking is described in detail hereinafter with reference to FIG. 5.

FIG. 5 is a block diagram illustrating an internal configuration of a server for providing an App ranking using use information of an App collected from an actual user, according to an exemplary embodiment of the present invention. As illustrated in FIG. 5, the App ranking providing system 500 may include a collecting unit 510 and a providing unit 520.

The collecting unit 510 may perform a task of collecting the use information of the App installed in a user terminal. The collecting unit 510 may receive and collect actual use information of an App in the user terminal from the user terminal, in conjunction with an information collecting App installed in the user terminal. The collecting unit 510 may collect (1) use information indicating a position of an icon of an App on a wallpaper of a user terminal, (2) use information indicating an App currently being executed in a memory of a user terminal, (3) use information indicating an App installed by being downloaded or updated in a user terminal for a predetermined recent period of time, (4) use information indicating an App being executed in a user terminal for a predetermined recent period of time, (5) use information indicating whether an App installed in a user terminal is provided at a predetermined fee or absent a fee, (6) use information indicating whether an App is recommended by a user of a user terminal. In addition, the collecting unit 510 may further collect information associated with a residence of a user who installed the information collecting App. Here, the user may agree to provide all of the is use information (1), (2), (3), (4), (5), and (6) and residence information as a whole, or agree to provide each of the use information (1), (2), (3), (4), (5), and (6) and residence information separately. Accordingly, the collecting unit 510 may select and collect information the user agrees to provide.

The providing unit 520 may aggregate an App ranking using the use information of the App including at least one of the use information (1), (2), (3), (4), (5) and (6) collected from the collecting unit 510. Here, at least one of the use information (1), (2), (3), (4), (5), and (6) may include a weight applied to each corresponding piece of information. For example, the use information (1) may include a weight applied to the position of the icon of the App on the wallpaper of the user terminal, and the use information (2) may include a weight applied to the App currently being executed in the memory of the user terminal. Accordingly, the providing unit 520 may aggregate an App ranking by calculating a sum of a total weight of the use information (1), (2), (3), (4), (5), and (6). Concisely, the providing unit 520 may aggregate the App ranking, using at least one of the use information (1), (2), (3), (4), (5), and (6), by considering at least one of a ranking according to an accessibility based on the position of the icon arranged by users, a ranking according to a real-time number of instances in which users are currently executing Apps, a ranking according to a number of instances in which the users install the Apps in the user terminal for a certain period of time, here an App provided at a predetermined fee is distinguished from an App provided absent a fee, a ranking according to a number of instances in which the users actually execute the Apps for a certain period of time, and a ranking according to a number of instances in which the users recommend the Apps for a certain period of time. The providing unit 520 may aggregate the App ranking by combining all of the use information (1), (2), (3), (4), (5), and (6), or by selecting each or a pieces of the use information (1), (2), (3), (4), (5), and (6). Furthermore, the providing unit 520 may aggregate, based on a residence of users who collect the use information of the App, a nationwide ranking of the App, a ranking of the App for each nation, and a ranking of the App for each region in the each nation. The aforementioned providing unit 520 may provide the App ranking being aggregated using at least one of the use information (1), (2), (3), (4), (5), and (6), via an information collecting App or a different App, or on various platforms.

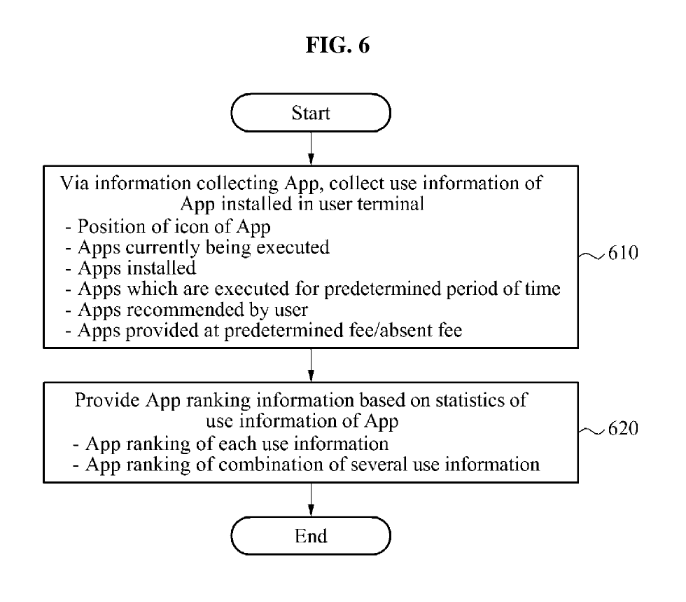

FIG. 6 is a flowchart illustrating a method for providing an App ranking using use information of an App collected from an actual user according to an exemplary embodiment of the present invention. Each operation of the method for providing the App ranking according to the present exemplary embodiment may be performed by the App ranking providing system 500 of FIG. 5.

In operation 610, the App ranking providing system 500 may receive and collect actual use information of an App in a user terminal from the user terminal in conjunction with an information collecting App installed in the user terminal. Here, the App ranking providing system 500 may collect the use information of the App including at least one of use information indicating a position of an icon of an App on a wallpaper of a user terminal, use information indicating an App currently being executed in a memory of a user terminal, use information indicating an App installed by being downloaded or updated in a user terminal for a certain period of time recently, use information indicating an App being executed in a user terminal for a certain period of time recently, use information indicating whether an App installed in a user terminal is provided at a predetermined fee or absent a fee, and use information indicating whether an App is recommended by a user of a user terminal. Also, the App ranking providing system 500 may further collect information associated with a residence of a user who installs the is information collecting App.

In operation 620, the App ranking providing system 500 may provide the App ranking being aggregated using the use information of the App. The App ranking providing system 500 may aggregate the App ranking, using the use information of the App, by considering at least one of a ranking based on an accessibility based on the position of the icon arranged by users, a ranking based on a real-time number of instances in which the users are currently executing Apps, a ranking based on a number of instances in which the users install the Apps in the user terminal for a certain period of time, here an App provided at a predetermined fee is distinguished from an App provided absent a fee, a ranking based on a number of instances in which the users actually execute the Apps for a certain period of time, and a ranking based on a number of instances in which the users recommend the Apps for a certain period of time. In addition, the App ranking providing system 500 may aggregate, based on the residence of the user who collects the use information of the App, a nationwide ranking of the App, a ranking of the App for each nation, and a ranking of the App for each region in the each nation.

Thus, the present exemplary embodiment may provide the App ranking, using a variety of information obtained from a terminal of a user who actually uses an App, and may aggregate the App ranking by evaluating an accessibility based on a position of an icon arranged by users, or may aggregate a real-time popular App ranking by analyzing an App currently being executed by a greatest number of the users.

The exemplary embodiments according to the present invention may be recorded in computer-readable media including program instructions to implement various operations embodied by a computer. Particularly, the exemplary embodiments according to the present invention may be recorded in computer-readable media storing program to include an is information collecting code to collect at least one of use information indicating a position of an icon of an App on a wallpaper of a user terminal, that is, an application managing interface, and use information indicating an App currently being executed in a memory of a user terminal, and an information transmission code to transmit use information to an App ranking providing system. Here, the information collecting code may further collect at least one of use information indicating an App newly installed by downloading or updating in a user terminal for a certain period of time, use information indicating an App which is executed in the user terminal for a certain period of time, use information indicating whether an App installed in a user terminal is provided at a predetermined fee or absent a fee, and use information indicating whether an App is recommended by a user of a user terminal. The aforementioned use information of the App may be used as a ranking determining factor to determine an App ranking in the App ranking providing system. A program according to the exemplary embodiments of the present invention may include a PC-based program or an application exclusive to a mobile device, for example, in a form of a smart phone application, a feature phone virtual machine (VM), etc., and the like. The program may be configured to be stored in a memory of a user terminal and/or the App ranking providing system, and implemented by more than one processor operated in the user terminal and/or the App ranking providing system.

The media may also include, alone or in combination with the program instructions, data files, data structures, and the like. The media and program instructions may be those specially designed and constructed for the purposes of the present invention, or they may be of the kind well-known and available to those having skill in computer software arts. Further, the file system recited above may be recorded in computer-readable media.

According to exemplary embodiments of the present invention, by providing a is combined ranking of an application on the Internet using various features obtainable from a terminal of a user who actually utilizes an application, useful information of introducing and recommending the application may be provided, thereby enabling a convenient search for the application to be provided for other users.

According to exemplary embodiments of the present invention, by providing a ranking of an application based on a position of an icon of an application arranged on an application managing interface of a user terminal by a user, frequently used applications arranged in a position with a high accessibility by a user may be introduced.

According to exemplary embodiments of the present invention, by providing a real-time ranking of an application currently being executed most frequently by terminal users, a real-time popular application apart from ranking information based on the preceding day may be introduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A communication terminal comprising:
one or more processors;
a memory; and
a program,
wherein the program is configured to be stored at least in part in the memory and executed at least in part by the one or more processors, and comprises at least one first application and a second application configured to collect use information associated with the first application,
wherein the second application comprises:
an information collecting code configured to collect at least one of use information indicating a position of an icon of the first application on a wallpaper which is an application managing interface of the communication terminal, and use information indicating the first application currently being executed; and
an information transmission code to transmit the use information to a host system is associated with the second application.
wherein the use information is used as a ranking determining factor to determine a ranking of the first application in the host system.

2. The communication terminal of claim 1, wherein the use information indicating the position of the icon of the first application comprises a weight applied to the position at which the icon of the first application is arranged on the wallpaper.

3. The communication terminal of claim 2, wherein in a case of the weight being applied to a position, when the wallpaper includes a plurality of pages, a weight applied to an icon arranged in an earlier front page is relatively higher than a weight applied to an icon arranged in a later back page.

4. The communication terminal of claim 2, wherein in the case of the weight being applied to a position, when the wallpaper includes a plurality of pages, a weight applied to an icon arranged earlier on a page is relatively higher than an icon arranged later on a page among icons on a same page.

5. The communication terminal of claim 2, wherein in the case of the weight being applied to a position, when the wallpaper includes at least one page in which the wallpaper is divided into a plurality of regions, based on an access environment set on the wallpaper, a weight applied to an icon arranged in a region with a high user accessibility is relatively higher than a weight applied to an icon arranged in a region with a low user accessibility.

6. The communication terminal of claim 1, wherein the use information indicating the first application currently being executed comprises a weight applied to the first application currently being executed in the memory.

7. The communication terminal of claim 1, wherein the use information indicating the first application currently being executed is employed as the ranking determining factor to determine a real-time ranking of the first application currently being executed.

8. The communication terminal of claim 1, wherein the information collecting code further collects at least one of use information indicating the first application installed in the communication terminal, use information indicating the first application which is executed for a certain period of time, use information indicating whether the first application installed in the communication terminal is provided at a predetermined fee, and use information indicating whether the first application is recommended by a user of the communication terminal.

9. A server for providing ranking information of an application on the Internet, the server comprising:
a storage unit;
a collecting unit stored at least in part on the storage unit and configured to collect, with regard to at least one first application installed in a communication terminal, at least one of use information indicating a position of an icon of the first application on a wallpaper which is an application managing interface of a communication terminal and use information indicating the first application currently being executed in a memory of the communication terminal; and
a providing unit configured to provide a ranking of the first application based on statistics of the use information.

10. The server of claim 9, wherein the collecting unit is configured to collect the use information from the communication terminal comprising a second application configured to provide the use information associated with the first application.

11. The server of claim 9, wherein:
the use information indicating the position of the icon of the first application comprises a weight applied to the position at which the icon of the first application is arranged on the wallpaper, and
the providing unit is configured to provide the ranking of the first application based on the position of the icon, by aggregating the weight for each first application.

12. The server of claim 9, wherein the use information indicating the first application currently being executed comprises the weight applied to the first application currently being executed in the memory, and
the providing unit is configured to provide a real-time ranking of the first application currently being executed, by aggregating in real time the weight for each first application.

13. The server of claim 9, wherein the collecting unit configured to collect at least one of the use information indicating the first application installed in the communication terminal, the use information indicating the first application which is executed for a certain period of time, the use information indicating whether the first application installed in the communication terminal is provided at a predetermined fee, and the use information indicating whether the first application is recommended by a user of the communication terminal.

14. The server of claim 13, wherein the providing unit is configured to provide at least one of a ranking according to a number of instances in which the first application is installed, a ranking according to a number of instances in which the first application is executed, a ranking according to a number of instances in which the first application provided at a predetermined fee is installed, a ranking according to a number of instances of the first application provided absent a fee is installed, and a ranking according to a number of instances of the first application is recommended.

15. The server of claim 9, wherein the providing unit is configured to provide at least one of a nationwide ranking of the first application based on a residence of a user of the communication terminal, a ranking of the first application for each nation, and a ranking of the first application for each region of each nation.

16. A method that uses one or more processors to control a communication terminal in which at least one first application and a second application are installed, the second application to collect use information associated with the at least one first application, the method comprising:
collecting, using at least one of the one or more processors at least one of use information indicating a position of an icon of the at least one first application on a wallpaper which is an application managing interface of a communication terminal, and use information indicating the at least one first application currently being executed; and
transmitting the use information to a host system associated with the second application, wherein the use information is used as a ranking determining factor to determine a ranking of the first application in the host system.

17. The method of claim 16, wherein the use information indicating the position of the icon of the at least one first application comprises a weight applied to the position at which the icon of the at least one first application is arranged on the wallpaper.

18. The method of claim 17, wherein in the case of the weight applied to a position, when the wallpaper includes a plurality of pages, a weight applied to an icon arranged in an earlier front page is relatively higher than a weight applied to an icon arranged in a later back page.

19. The method of claim 17, wherein in the case of the weight applied to the position, when the wallpaper includes a plurality of pages, a weight applied to an icon arranged earlier on a page is relatively higher than an icon arranged later on a page between icons on a same page.

20. The method of claim 17, wherein in the case of the weight applied to the position, when the wallpaper includes at least one page in which the wallpaper is divided into a plurality of regions, based on an access environment set on the wallpaper, a weight applied to an icon arranged in a region with a high user accessibility is relatively higher than a weight applied to an icon arranged in a region with a low user accessibility.

21. The method of claim 17, wherein the use information indicating the at least one first application currently being executed comprises a weight applied to the first at least one application currently being executed in the memory by at least one of the one or more processors.

22. The method of claim 17, wherein the use information indicating the at least one first application currently being executed is employed as the ranking determining factor to determine a real-time ranking of the first at least one application currently being executed.

23. A non-transitory computer-readable recording medium storing an executable program to collect use information associated with at least one application installed in a communication terminal, wherein the program comprises:
an information collecting code to configured collect at least one of use information indicating a position of an icon of the application on a wallpaper, which is an application managing interface, and a use information indicating the application currently being executed; and
an information transmission code configured to transmit the use information to a server for providing ranking information of the application.
